(19) United States
(12) Patent Application Publication
(10) Pub. No.: US 2022/0070765 A1
(43) Pub. Date: Mar. 3, 2022

(54) VIRTUAL GATEWAY FOR MULTIPLE NETWORK CONNECTION ROUTES

(71) Applicant: Sony Corporation, Tokyo (JP)

(72) Inventor: Jenke Wu Kuo, San Diego, CA (US)

(73) Assignee: Sony Corporation, Tokyo (JP)

(21) Appl. No.: 17/011,943

(22) Filed: Sep. 3, 2020

(51) Int. Cl. H04W 48/18; H04L 12/723; H04L 12/24; H04L 12/46; H04L 12/66

(52) U.S. Cl. CPC H04W 48/18; H04L 45/50; H04L 12/66; H04L 12/4641; H04L 41/0893

(57) ABSTRACT

Embodiments generally relate to a virtual gateway for multiple network connection routes. In some embodiments, a method includes identifying at least one server for sourcing data. The method further includes establishing a first network connection to a first network associated with the at least one server. The method further includes fetching data from the at least one server via the first network based on a first network protocol. The method further includes establishing a second network connection to a second network associated with the at least one server. The method further includes switching from the first network to the second network based on one or more selection policies. The method further includes fetching data from the at least one server via the second network based on a second network protocol.

### BACKGROUND

Communication networks are widely used for providing communication between different computer systems and other electronic devices. Conventional consumer electronic media devices such as televisions, smart phones, etc. need to obtain data from the cloud or from other devices through network connections. Network connections have various protocols, transferring speeds and signal strength relaying on physical location and facility. Switch among various network connections is typically performed manually, which can be tedious, time consuming, and disruptive during data transfers.

### SUMMARY

Embodiments generally relate to a virtual gateway for multiple network connection routes. In some embodiments, a system includes one or more processors, and includes logic encoded in one or more non-transitory computer-readable storage media for execution by the one or more processors. When executed, the logic is operable to cause the one or more processors to perform operations including: identifying at least one server for sourcing data; establishing a first network connection to a first network associated with the at least one server; fetching data from the at least one server via the first network based on a first network protocol; establishing a second network connection to a second network associated with the at least one server; switching from the first network to the second network based on one or more selection policies; and fetching data from the at least one server via the second network based on a second network protocol.

With further regard to the system, in some embodiments, the logic when executed is further operable to cause the one or more processors to perform operations comprising identifying a plurality of candidate network connections for fetching data from the at least one server, wherein the plurality of candidate network connections comprises the first network connection and the second network connection. In some embodiments, the logic when executed is further operable to cause the one or more processors to perform operations comprising identifying a plurality of candidate network connections for fetching data from the at least one server based on one or more trigger policies. In some embodiments, the logic when executed is further operable to cause the one or more processors to perform operations comprising identifying a plurality of candidate network connections for fetching data from the at least one server based on one or more trigger policies, and wherein at least one trigger policy of the one or more trigger policies is based on movement of a client device. In some embodiments, the switching from the first network to the second network is performed seamlessly. In some embodiments, the logic when executed is further operable to cause the one or more processors to perform operations comprising selecting the second network connection from a plurality of candidate network connections based on the one or more selection policies. In some embodiments, the logic when executed is further operable to cause the one or more processors to perform operations comprising selecting the second network connection from a plurality of candidate network connections based on the one or more selection policies, and wherein at least one selection policy of the one or more selection policies is based on one or more performance criteria.

In some embodiments, a non-transitory computer-readable storage medium with program instructions thereon is provided. When executed by one or more processors, the instructions are operable to cause the one or more processors to perform operations including: identifying at least one server for sourcing data; establishing a first network connection to a first network associated with the at least one server; fetching data from the at least one server via the first network based on a first network protocol; establishing a second network connection to a second network associated with the at least one server; switching from the first network to the second network based on one or more selection policies; and fetching data from the at least one server via the second network based on a second network protocol.

With further regard to the computer-readable storage medium, in some embodiments, the instructions when executed are further operable to cause the one or more processors to perform operations comprising identifying a plurality of candidate network connections for fetching data from the at least one server, wherein the plurality of candidate network connections comprises the first network connection and the second network connection. In some embodiments, the instructions when executed are further operable to cause the one or more processors to perform operations comprising identifying a plurality of candidate network connections for fetching data from the at least one server based on one or more trigger policies. In some embodiments, the instructions when executed are further operable to cause the one or more processors to perform operations comprising identifying a plurality of candidate network connections for fetching data from the at least one server based on one or more trigger policies, and wherein at least one trigger policy of the one or more trigger policies is based on movement of a client device. In some embodiments, the switching from the first network to the second network is performed seamlessly. In some embodiments, the instructions when executed are further operable to cause the one or more processors to perform operations comprising selecting the second network connection from a plurality of candidate network connections based on the one or more selection policies. In some embodiments, the instructions when executed are further operable to cause the one or more processors to perform operations comprising selecting the second network connection from a plurality of candidate network connections based on the one or more selection policies, and wherein at least one selection policy of the one or more selection policies is based on one or more performance criteria.

In some embodiments, a method includes: identifying at least one server for sourcing data; establishing a first network connection to a first network associated with the at least one server; fetching data from the at least one server via the first network based on a first network protocol; establishing a second network connection to a second network associated with the at least one server; switching from the first network to the second network based on one or more selection policies; and fetching data from the at least one server via the second network based on a second network protocol.

With further regard to the method, in some embodiments, the method further includes identifying a plurality of candidate network connections for fetching data from the at least one server, wherein the plurality of candidate network connections comprises the first network connection and the second network connection. In some embodiments, the method further includes identifying a plurality of candidate network connections for fetching data from the at least one server based on one or more trigger policies. In some embodiments, the method further includes identifying a plurality of candidate network connections for fetching data from the at least one server based on one or more trigger policies, and wherein at least one trigger policy of the one or more trigger policies is based on movement of a client device. In some embodiments, the switching from the first network to the second network is performed seamlessly. In some embodiments, the method further includes selecting the second network connection from a plurality of candidate network connections based on the one or more selection policies.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example media environment for providing a virtual gateway for multiple network connections, which may be used for embodiments described herein.

FIG. 2 illustrates an example flow diagram for providing a virtual gateway for multiple network connections, according to some embodiments.

FIG. 3 is a block diagram of an example network environment, which may be used for some embodiments described herein.

FIG. 4 is a block diagram of an example computer system, which may be used for some embodiments described herein.

### DETAILED DESCRIPTION

Embodiments described herein enable, facilitate, and manage a virtual gateway for multiple network connections. As described in more detail herein, in various embodiments, a system identifies at least one server for sourcing data. The system then establishes a first network connection to a first network associated with the at least one server. The system then fetches data from the at least one server via the first network based on a first network protocol. The system then establishes a second network connection to a second network associated with the at least one server. The system then switches from the first network to the second network based on one or more selection policies. The system then fetches data from the at least one server via the second network based on a second network protocol.

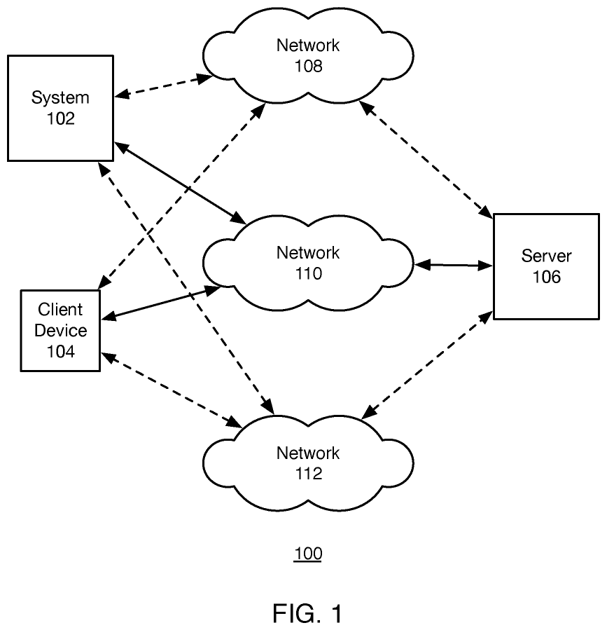

FIG. 1 is a block diagram of an example environment 100 for providing a virtual gateway for multiple network connections, which may be used for embodiments described herein. In some implementations, environment 100 includes a system 102, a client device 104, a server 106, a network 108, a network 110, and a network 112. System 102, client device 104, and server 106 may communicate with each other via networks 108, 110, and 112.

In some implementations, the network may be the Internet. In some implementations, the network may include a combination of networks such as the Internet, a wide area network (WAN), a local area network (LAN), an Ethernet network, a Wi-Fi network, a Bluetooth network, near-field communication (NFC) network, cable network, the Internet, cellular networks including 4th generation (4G), 5th generation (5G), etc.

Client device 104 may be any consumer electronic device such as a smart phone, tablet, computer, smart watch, etc., which fetches data from server 106. For example, client device 104 may be used as a media device for streaming videos from server 106. In various embodiments, server 106 may be associated with a service provider. For example, the service provider may be a service provider that sources streaming video to end users.

For ease of illustration, FIG. 1 shows one block for each of system 102, client device 104, and server 106, and shows three networks 108, 110, and 112. Blocks 102, 104, and 106 may represent multiple systems, client devices, and servers. Also, there may be any number of networks. In other embodiments, environment 100 may not have all of the components shown and/or may have other elements including other types of elements instead of, or in addition to, those shown herein.

While system 102 performs embodiments described herein, in other embodiments, any suitable component or combination of components associated with system 102 or any suitable processor or processors associated with system 102 may facilitate performing the embodiments described herein.

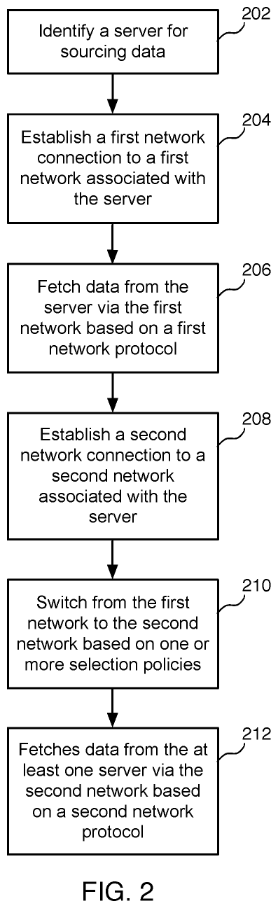

FIG. 2 illustrates an example flow diagram for providing a virtual gateway for multiple network connections, according to some embodiments. In various embodiments, the virtual gateway may detect, bypass, cache, switch, and/or transcode various network protocols seamlessly. This enables an end user to enjoy seamless data transfer from a server and/or service that sources such data. Referring to both FIGS. 1 and 2, a method is initiated at block 202, where a system such as system 102 identifies a server such as server 106 for sourcing data. As indicated herein, server 106 may be associated with a service provider such as a service provider that provides streaming movies, television shows, etc., for example. The particular type of data may vary, depending on the particular implementation. For example, in some embodiments, the data may be video data (e.g., movies, television shows, etc.). In some embodiments, the data may be audio (e.g., music, sounds, etc.). Such data may also include data from a website, documents, etc.

At block 204, system 102 establishes a first network connection to a first network associated with the server.

At block 206, system 102 fetches data from the server via the first network based on a first network protocol. In various embodiments, system 102 manages the fetching of data through multiple network connection routes including the first network. In various embodiments, during runtime performance, system 102 optimizes data fetching smoothly with the multiple network connections through a switching bypass mode and a caching mode. In the bypass mode, system 102 bypasses particular network connections (e.g., non-available network connections, sub-optimal network connections, etc.). In the caching mode, system 102 manages data buffering in order to achieve seamless switching from one network connection to another network connection.

At block 208, system 102 establishes a second network connection to a second network associated with the server. In various embodiments, before establishing the second network connection, system 102 may identify one or more candidate network connections for fetching data from the server. The candidate network connections may include, for example, the first network connection, the second network connection, a third network connection, etc. The system may then select a network connection from among the available group of network connections. Example embodiments directed to identifying candidate network connections are described in more detail herein.

At block 210, system 102 switches from the first network to the second network based on one or more selection policies. In some embodiments, each network connection may be associated with a unique connection channel. As such, system 102 may switch network connections by switching connection channels (e.g., switching from Channel 1 to Channel 2, etc.).

At block 212, system 102 fetches data from the at least one server via the second network based on a second network protocol. In various embodiments, system 102 switches from the first network connection to the second network connection seamlessly. In some embodiments, the switch occurs seamlessly in that the user does not notice the switch from one network connection to another network connection. In some embodiments, the switch occurs seamlessly in that the user does not need to manually switch the network from one to the other.

The following describes other embodiments that system 102 may apply in combination with one or more other embodiments described herein. For example, as indicated above, in various embodiments, before establishing the second network connection, system 102 may identify one or more candidate network connections for fetching data from the server.

In various embodiments, system 102 identifies one or more candidate network connections for fetching data from the server based on one or more trigger policies. The trigger policies may vary, depending on the particular implementation. For example, in some embodiments, one of the trigger policies is based on movement of a client device. For example, the movement of the client device may involve the client device moving from one location to another location, as the user holding the client device walks from the one location to the other location.

In some embodiments, one of the trigger policies is to identify one or more candidate network connections based on movement of a client device from a predetermined area. In some embodiments, one trigger policy is to establish one or more network connections based on movement of a client device to a predetermined area. In various embodiments, system 102 switching from the first network to the second network is performed seamlessly.

In various embodiments, system 102 selects the second network connection from the one or more candidate network connections based on the one or more selection policies. The selection policies may vary, depending on the particular implementation. For example, in some embodiments, one of the selection policies is based on one or more performance criteria. In various embodiments, at least one performance criterion is signal strength. For example, the system may switch to a network connection with a stronger signal.

In various embodiments, system 102 selects a candidate network connection from among multiple candidate network connections based on a performance score. In various embodiments, system 102 computes one or more performance scores. In various embodiments, the performance scores include a performance score for each candidate network connection. The system ranks the performance scores, and then selects the candidate network connection based on the ranking.

In some embodiments, the performance score is based on the signal strength of each network connection. For example, system 102 may select a given network connection that has the highest signal strength. In some embodiments, system 102 may select a given network connection that has a highest signal strength that meets a predetermined criteria.

In some embodiments, the performance score is based on the data cost associated with each network. For example, some service providers may charge more for data than other service provides. As such, system 102 may select a given network connection based on available service providers associated with the network connection, where system 102 selects the network connection associated with a lower data cost.

In some embodiments, the performance score is based on the bandwidth associated with each network. For example, some network connections may have more bandwidth than other network connections. As such, system 102 may select a given network connection with the most bandwidth. In some embodiments, system 102 may select a given network connection with a bandwidth that meets a predetermined amount of bandwidth.

In some embodiments, the performance score is based on a type of activity associated with each network. For example, some network connections may be associated with one or more networks and respective service providers that provide particular types of media entertainment. For example, a given service provider may source movies, television shows, etc. Another service provider may source music, etc. In some embodiments, system 102 may select a given network connection with such particular media content types.

In some embodiments, the performance score is based on a type of client device being used. For example, some network connections may be optimized for particular types of client devices (e.g., televisions). In some embodiments, system 102 may select a given network connection that is optimized for the device being used.

In various embodiments, the performance score may be based on any one or more types of information described herein. For example, the performance score may be based on an aggregate of any combination of performance scores associated with signal strength, bandwidth, activity, client device type, etc.

In various embodiments, system 102 applies one or more network protocols to transcode data. Such transcoding may involve, for example, decompressing already-compressed (or encoded) content and optionally altering and/or recompressing the data. For example, system 102 may convert data in one audio format and/or video format (codec) to another format such as to H.264 video and Advanced Audio Coding (AAC) audio. Transcoding may also involve transrating, which may in turn involve changing bitrates (e.g., 1 Mbps, 2 Mbps, 2 Mbps, etc.). Transcoding may also involve transsizing, which may involve resizing the video frame (e.g., to 1920×1080, etc.). In various embodiments, system 102 may cache the data in the virtual gateway and filter out the redundancy data from different network routes.

In various embodiments, system 102 determines one or more nodes in a network system with at least one port that is enabled for security-enabled services. In various embodiments, system 102 provisions a connectivity association for each node, where each connectivity association is provisioned with a connectivity association key. In various embodiments, system 102 associates each connectivity association with a virtual service network (VSN). In various embodiments, system 102 mutually authenticates nodes on each VSN based on each respective connectivity association key.

In various embodiments, the system may utilize artificial intelligent (AI) and machine learning in order to manage the user profiles as well as to carry out the embodiments described herein. For example, the system may perform any one or more steps described in connection with FIG. 2 using AI and machine learning.

Although the steps, operations, or computations may be presented in a specific order, the order may be changed in particular embodiments. Other orderings of the steps are possible, depending on the particular embodiment. In some particular embodiments, multiple steps shown as sequential in this specification may be performed at the same time. Also, some embodiments may not have all of the steps shown and/or may have other steps instead of, or in addition to, those shown herein.

Embodiments described herein provide various benefits. For example, embodiments enable seamless switching from one network connection to another. Embodiments perform such switching automatically without user intervention.

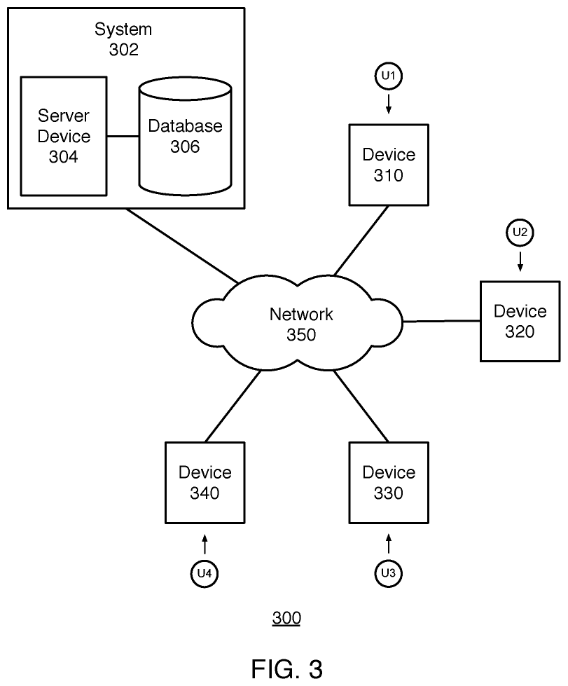

FIG. 3 is a block diagram of an example network environment 300, which may be used for some embodiments described herein. In some embodiments, network environment 300 includes a system 302, which includes a server device 304 and a database 306. For example, system 302 may be used to implement system 102 of FIG. 1, as well as to perform embodiments described herein. Network environment 300 also includes client devices 310, 320, 330, and 340, which may communicate with system 302 and/or may communicate with each other directly or via system 302. Network environment 300 also includes a network 350 through which system 302 and client devices 310, 320, 330, and 340 communicate. Network 350 may be any suitable communication network such as a Wi-Fi network, Bluetooth network, the Internet, etc.

For ease of illustration, FIG. 3 shows one block for each of system 302, server device 304, and database 306, and shows four blocks for client devices 310, 320, 330, and 340. Blocks 302, 304, and 306 may represent multiple systems, server devices, and databases. Also, there may be any number of client devices. In other embodiments, environment 300 may not have all of the components shown and/or may have other elements including other types of elements instead of, or in addition to, those shown herein.

While server device 304 of system 302 performs embodiments described herein, in other embodiments, any suitable component or combination of components associated with system 302 or any suitable processor or processors associated with system 302 may facilitate performing the embodiments described herein.

In the various embodiments described herein, a processor of system 302 and/or a processor of any client device 310, 320, 330, and 340 cause the elements described herein (e.g., information, etc.) to be displayed in a user interface on one or more display screens.

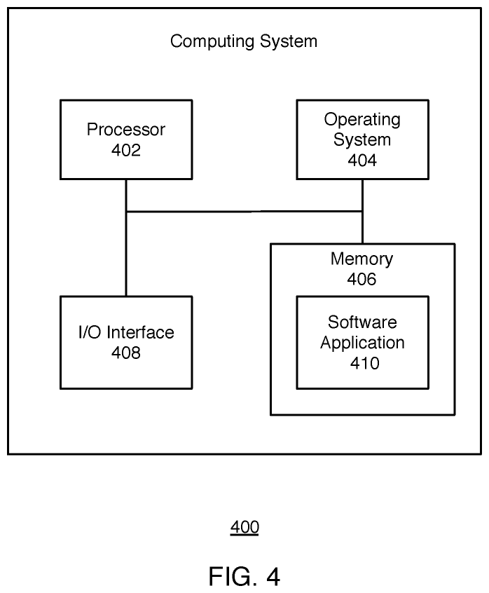

FIG. 4 is a block diagram of an example computer system 400, which may be used for some embodiments described herein. For example, computer system 400 may be used to implement server device 304 of FIG. 3 and/or system 102 of FIG. 1, as well as to perform embodiments described herein. In some embodiments, computer system 400 may include a processor 402, an operating system 404, a memory 406, and an input/output (I/O) interface 408. In various embodiments, processor 402 may be used to implement various functions and features described herein, as well as to perform the method embodiments described herein. While processor 402 is described as performing embodiments described herein, any suitable component or combination of components of computer system 400 or any suitable processor or processors associated with computer system 400 or any suitable system may perform the steps described. Embodiments described herein may be carried out on a user device, on a server, or a combination of both.

Computer system 400 also includes a software application 410, which may be stored on memory 406 or on any other suitable storage location or computer-readable medium. Software application 410 provides instructions that enable processor 402 to perform the embodiments described herein and other functions. Software application may also include an engine such as a network engine for performing various functions associated with one or more networks and network communications. The components of computer system 400 may be implemented by one or more processors or any combination of hardware devices, as well as any combination of hardware, software, firmware, etc.

For ease of illustration, FIG. 4 shows one block for each of processor 402, operating system 404, memory 406, I/O interface 408, and software application 410. These blocks 402, 404, 406, 408, and 410 may represent multiple processors, operating systems, memories, I/O interfaces, and software applications. In various embodiments, computer system 400 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and embodiments.

In various embodiments, software is encoded in one or more non-transitory computer-readable media for execution by one or more processors. The software when executed by one or more processors is operable to perform the embodiments described herein and other functions.

Any suitable programming language can be used to implement the routines of particular embodiments including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the embodiments described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
identifying at least one server for sourcing data;
establishing a first network connection to a first network associated with the at least one server;
fetching data from the at least one server via the first network based on a first network protocol;
establishing a second network connection to a second network associated with the at least one server;
switching from the first network to the second network based on one or more selection policies; and
fetching data from the at least one server via the second network based on a second network protocol.

2. The system of claim 1, wherein the logic when executed is further operable to cause the one or more processors to perform operations comprising identifying a plurality of candidate network connections for fetching data from the at least one server, and wherein the plurality of candidate network connections comprises the first network connection and the second network connection.

3. The system of claim 1, wherein the logic when executed is further operable to cause the one or more processors to perform operations comprising identifying a plurality of candidate network connections for fetching data from the at least one server based on one or more trigger policies.

4. The system of claim 1, wherein the logic when executed is further operable to cause the one or more processors to perform operations comprising identifying a plurality of candidate network connections for fetching data from the at least one server based on one or more trigger policies, and wherein at least one trigger policy of the one or more trigger policies is based on movement of a client device.

5. The system of claim 1, wherein the switching from the first network to the second network is performed seamlessly.

6. The system of claim 1, wherein the logic when executed is further operable to cause the one or more processors to perform operations comprising selecting the second network connection from a plurality of candidate network connections based on the one or more selection policies.

7. The system of claim 1, wherein the logic when executed is further operable to cause the one or more processors to perform operations comprising selecting the second network connection from a plurality of candidate network connections based on the one or more selection policies, and wherein at least one selection policy of the one or more selection policies is based on one or more performance criteria.

8. A non-transitory computer-readable storage medium with program instructions stored thereon, the program instructions when executed by one or more processors are operable to cause the one or more processors to perform operations comprising:
identifying at least one server for sourcing data;
establishing a first network connection to a first network associated with the at least one server;
fetching data from the at least one server via the first network based on a first network protocol;
establishing a second network connection to a second network associated with the at least one server;
switching from the first network to the second network based on one or more selection policies; and
fetching data from the at least one server via the second network based on a second network protocol.

9. The computer-readable storage medium of claim 8, wherein the instructions when executed are further operable to cause the one or more processors to perform operations comprising identifying a plurality of candidate network connections for fetching data from the at least one server, and wherein the plurality of candidate network connections comprises the first network connection and the second network connection.

10. The computer-readable storage medium of claim 8, wherein the instructions when executed are further operable to cause the one or more processors to perform operations comprising identifying a plurality of candidate network connections for fetching data from the at least one server based on one or more trigger policies.

11. The computer-readable storage medium of claim 8, wherein the instructions when executed are further operable to cause the one or more processors to perform operations comprising identifying a plurality of candidate network connections for fetching data from the at least one server based on one or more trigger policies, and wherein at least one trigger policy of the one or more trigger policies is based on movement of a client device.

12. The computer-readable storage medium of claim 8, wherein the switching from the first network to the second network is performed seamlessly.

13. The computer-readable storage medium of claim 8, wherein the instructions when executed are further operable to cause the one or more processors to perform operations comprising selecting the second network connection from a plurality of candidate network connections based on the one or more selection policies.

14. The computer-readable storage medium of claim 8, wherein the instructions when executed are further operable to cause the one or more processors to perform operations comprising selecting the second network connection from a plurality of candidate network connections based on the one or more selection policies, and wherein at least one selection policy of the one or more selection policies is based on one or more performance criteria.

15. A computer-implemented method comprising:
identifying at least one server for sourcing data;
establishing a first network connection to a first network associated with the at least one server;
fetching data from the at least one server via the first network based on a first network protocol;
establishing a second network connection to a second network associated with the at least one server;
switching from the first network to the second network based on one or more selection policies; and
fetching data from the at least one server via the second network based on a second network protocol.

16. The method of claim 15, further comprising identifying a plurality of candidate network connections for fetching data from the at least one server, wherein the plurality of candidate network connections comprises the first network connection and the second network connection.

17. The method of claim 15, further comprising identifying a plurality of candidate network connections for fetching data from the at least one server based on one or more trigger policies.

18. The method of claim 15, further comprising identifying a plurality of candidate network connections for fetching data from the at least one server based on one or more trigger policies, and wherein at least one trigger policy of the one or more trigger policies is based on movement of a client device.

19. The method of claim 15, wherein the switching from the first network to the second network is performed seamlessly.

20. The method of claim 15, further comprising selecting the second network connection from a plurality of candidate network connections based on the one or more selection policies.
